(19) United States
(12) Patent Application Publication
(10) Pub. No.: US 2026/0339763 A1
(43) Pub. Date: Oct. 29, 2026

(54) MEMORY ACCESS FAULT CLUSTERING WITHOUT MEMORY FOOTPRINT INCREASE

(71) Applicant: Microsoft Technology Licensing, LLC, Redmond, WA (US)

(72) Inventors: Yevgeniy M. BAK, Redmond, WA (US); Landy WANG, Menlo Park, CA (US)

(21) Appl. No.: 19/191,930

(22) Filed: Apr. 28, 2025

(51) Int. Cl. G06F 11/07; G06F 9/50

(52) U.S. Cl. CPC G06F 11/073; G06F 9/5016; G06F 11/079

(57) ABSTRACT

A device identifies a first page fault resulting from an access by a processor system to an invalid first page table entry (PTE). The device identifies a plurality of PTEs as a fault clustering unit, the plurality of PTEs being contiguous and including the first PTE. The device satisfies the fault clustering unit, including allocating a different memory page to each PTE in the plurality of PTEs and marking each PTE as valid. After a subsequent page fault, the device confirms the fault clustering unit, including determining whether a threshold number of PTEs in the plurality of PTEs were accessed after the first page fault. If the threshold is not met, the device trims the fault clustering unit, including deallocating a memory page from a PTE in the plurality of PTEs that was not accessed after the first page fault and marking the PTE as invalid.

### BACKGROUND

In modern computing systems, virtual memory is a fundamental mechanism that allows the execution of processes without requiring all their data to be loaded into physical random access memory (RAM) simultaneously. This abstraction enables more efficient physical memory utilization and simplifies memory management. However, virtual memory introduces complexities, particularly when a program attempts to access data that is not currently resident in physical memory, leading to events known as page faults.

A page fault occurs when an executing context (e.g., thread, process) tries to access a memory page that is mapped in the virtual address space but is not loaded into physical memory. This situation triggers a trap at the processor, which then executes a fault handler in the operating system (OS) to handle the fault to continue the context's execution. The typical procedure for handling a page fault involves several steps. For example, handling a page fault can involve validation, in which the OS checks the memory access to ensure it is valid (e.g., to a valid memory page). If it is invalid, the OS may terminate the context. If the access is valid, handling a page fault can also involve locating a memory page, which may involve identifying the page's position on a disk or within a swap space. Handling a page fault can also involve allocating a frame, whereby the system searches for a free frame in physical memory. If no free frame is available, a page replacement algorithm is employed to select a frame to be swapped out. Handling a page fault can also involve reading the located page from the disk into the allocated frame. Handling a page fault can also involve updating a page table to reflect the new mapping of the virtual address to the physical frame, including resetting an invalid bit in a page table entry to indicate that the page is now in memory. Handling a page fault can also involve resuming execution, including restarting the instruction that caused the page fault, allowing the context to continue its execution.

Handling page faults incurs significant performance costs. An executing context is suspended while the OS resolves the fault, leading to increased latency for the context. Additionally, the OS's involvement leads to context switching (e.g., from the executing context to the OS and back again) and the execution of page replacement algorithms, which can further degrade system performance. Frequent page faults can lead to a condition known as thrashing, where the system spends more time handling faults than executing actual code, severely impacting overall system efficiency.

Moreover, it may be necessary to acquire locks on shared data structures, such as a page table, during page fault handling, which can introduce scalability challenges in multi-processor systems. Contending for these locks by multiple processors can lead to bottlenecks, reducing the parallel efficiency of the system and limiting the performance gains expected from multiple processors.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying a first page fault resulting from a first access by the processor system to a first page table entry (PTE) that is invalid; identifying a plurality of PTEs as a fault clustering unit, the plurality of PTEs being contiguous and including the first PTE; satisfying the fault clustering unit, including allocating a different memory page to each PTE in the plurality of PTEs and marking each PTE in the plurality of PTEs as valid; and after a subsequent page fault, confirming the fault clustering unit, including: determining that a threshold number of PTEs in the plurality of PTEs were not accessed after the first page fault; and trimming the fault clustering unit, including deallocating a memory page from a PTE in the plurality of PTEs that was not accessed after the first page fault, and marking the PTE as invalid.

In some aspects, the techniques described herein relate to methods, systems, and computer program products, including: identifying a first page fault resulting from a first access by the processor system to a first page PTE that is invalid, the first page fault resulting from a first memory access by an execution context; identifying a plurality of PTEs as a fault clustering unit, the plurality of PTEs being contiguous and including the first PTE; satisfying the fault clustering unit, including allocating a different memory page to each PTE in the plurality of PTEs and marking each PTE in the plurality of PTEs as valid; and after a subsequent page fault, confirming the fault clustering unit, including: determining that a threshold number of PTEs in the plurality of PTEs were accessed after the first page fault; and adjusting a fault clustering policy to increase an amount of future fault clustering for the execution context.

In some aspects, the techniques described herein relate to methods, systems, and computer program products, including: identifying a first page fault resulting from a first access by the processor system to a first page PTE that is invalid, the first page fault resulting from a first memory access by an execution context; identifying a plurality of PTEs as a fault clustering unit, the plurality of PTEs being contiguous and including the first PTE; satisfying the fault clustering unit, including: allocating a different memory page to each PTE in the plurality of PTEs; and marking each PTE in the plurality of PTEs as valid; identifying a second page fault resulting from a second access by the processor system to a second PTE that is invalid, the second page fault resulting from a second memory access by the execution context; determining that a threshold number of PTEs in the plurality of PTEs were not accessed after the first page fault; and trim the fault clustering unit, including: deallocating a corresponding memory page from each PTE in the plurality of PTEs that was not accessed after the first page fault; and marking the PTE as invalid.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates fault clustering by periodically confirming the success of a prior fault clustering unit, including checking whether a proactively fetched page has been accessed within a defined period;

FIG. 2 illustrates an example of a page fault handler that periodically confirms the success of fault clustering;

FIG. 3 illustrates an example of confirming a fault clustering unit, including trimming the fault clustering unit when proactively satisfied pages were not accessed;

FIG. 4 illustrates an example of confirming a fault clustering unit, including confirming that proactively-satisfied pages were accessed; and

FIG. 5 illustrates a flow chart of an example of a method for fault clustering that periodically confirms the success of the clustering by checking whether the proactively fetched pages have been accessed.

### DETAILED DESCRIPTION

In modern computing systems, programs often use more memory than is physically available. To manage this, systems use a technique called virtual memory, which allows programs to use memory as if there is more available than physically exists. When a program tries to access data that isn't currently in physical memory, it triggers an event known as a page fault. This requires the system to fetch the data from a slower storage medium, which can significantly slow down the program's execution.

Due to the performance costs of handling page faults, some operating systems (OSs) perform fault clustering, proactively loading multiple pages into memory after a page fault, rather than loading a single requested page as is conventional. This anticipation amortizes some of the fixed costs of taking a page fault and reduces the likelihood of future page faults, leading to smoother program execution. While beneficial for reducing page faults, using fault clustering to load data into memory before it is explicitly requested by a program can increase the apparent memory usage of a system. It also leads to a larger memory footprint, as more data is held in memory than may be immediately necessary.

The embodiments described herein introduce a fault clustering technique that continuously confirms the success of the clustering by checking whether the proactively fetched pages have been accessed within a defined period. If the clustered pages have not been accessed, they are trimmed from the working set, thereby eliminating the memory footprint impact. Thus, the embodiments described herein gain the advantages of fault clustering—such as reducing the likelihood of future page faults and leading to smoother program execution—while avoiding the disadvantages of an increased memory footprint. In one embodiment, a method involves identifying a page fault resulting from access by a processor system to a page table entry (PTE) that is invalid (e.g., not presently mapped to a physical memory page). A plurality of contiguous PTEs that includes the PTE is identified as a fault clustering unit. The fault clustering unit is satisfied by allocating a different physical memory page to each PTE in the plurality and marking each PTE as valid. After a subsequent page fault, the fault clustering unit is confirmed by determining whether a threshold number of PTEs in the plurality were accessed after the initial page fault and trimming the fault clustering unit if the threshold was not met.

By clustering pages and confirming their usage, the embodiments can avoid unnecessary memory consumption, thus maintaining a more efficient memory footprint while reducing page faults. Additionally, embodiments can dynamically adjust the aggressiveness of fault clustering for an execution context based on the success of prior fault clustering for the execution context. For example, embodiments may dynamically adjust the fault clustering unit size (e.g., to increase or decrease the number of proactively-allocated pages), and/or dynamically adjusting the threshold of accessed PTE used to determine if a fault clustering unit should be trimmed or not (e.g., to increase or decrease the aggressiveness of trimming). This dynamic adjustment ensures that a system can adapt to varying workloads.

Additionally, embodiments can address scalability challenges in multi-processor systems by allowing each thread to perform its own verification, thereby avoiding bottlenecks associated with lock contention. Furthermore, embodiments can benefit processors that perform automatic translation lookaside buffer (TLB) coalescing in hardware by allocating contiguous and aligned memory pages that are readily coalesced within a TLB, which can increase the reach of a TLB and improve memory access performance by the processor. Furthermore, embodiments can emphasize allocating contiguous memory pages when clustering and deallocating those pages as a unit, reducing overall system memory fragmentation.

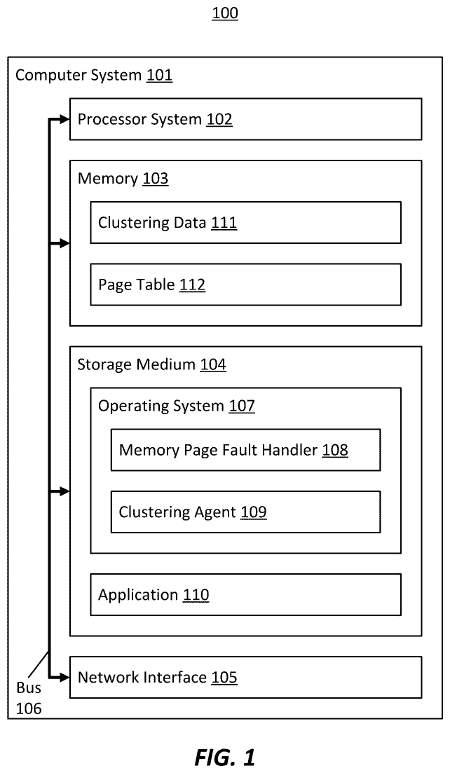

FIG. 1 illustrates example 100 of a computer architecture that facilitates fault clustering by periodically confirming the success of a prior fault clustering unit, including checking whether a proactively fetched page has been accessed within a defined period. Example 100 includes a computer system 101 comprising a processor system 102 (e.g., a single processor or a plurality of processors), memory 103 (e.g., system or main memory), a storage medium 104 (e.g., a single computer-readable storage medium, or a plurality of computer-readable storage media), all interconnected by a bus 106. As shown, computer system 101 may also include a network interface 105 (e.g., one or more network interface cards) for interconnecting (via a network) to another computer system (e.g., a single computer system or a plurality of computer systems).

FIG. 1 illustrates storage medium 104 as storing computer-executable instructions implementing an OS 107 and an application 110 (or a plurality of applications). OS 107 includes a memory page fault handler 108 that periodically confirms the success of prior fault clustering by the memory page fault handler 108 for a given execution context, such as a thread of OS 107 or application 110, a process of OS 107 or application 110, a virtual machine (VM), or a container (e.g., a DOCKER container). Notably, while the memory page fault handler 108 is illustrated as being part of an OS (OS 107) that executes directly on processor system 102 (e.g., a “bare metal” OS), the embodiments described herein are applicable to various types of memory page fault handlers, such as a memory page fault handler that executes within a guest OS of VM or a memory page fault handler of a hypervisor.

In embodiments, in connection with handling a first page fault for an execution context, the memory page fault handler 108 performs a fault clustering operation to proactively make one or more PTEs valid for the execution context. In embodiments, in connection with handling a subsequent second page fault for an execution context, the memory page fault handler 108 then confirms the success of the prior fault clustering operation. Confirming the success of a prior fault clustering operation can include trimming one or more PTEs that were proactively made valid if those PTEs were not accessed by the execution context. Additionally, or alternatively, confirming the success of a prior fault clustering operation can include adjusting a fault clustering policy (e.g., based on whether one or more PTEs that were proactively made valid were accessed by the execution context).

By performing the fault clustering operation, the memory page fault handler 108 reduces the likelihood of future page faults by the execution context, leading to smoother execution of the execution context, and potentially of other execution contexts executing at the computer system 101. In addition, by confirming the success of the fault clustering operation and trimming non-accessed memory pages if present, the memory page fault handler 108 avoids unnecessary memory consumption and maintains a more efficient memory footprint for the execution context.

In some embodiments, OS 107 also includes a clustering agent 109 that periodically confirms the success of fault clustering by the memory page fault handler 108 for a plurality of execution contexts. For example, in addition to, or as an alternative to, the memory page fault handler 108 confirming the success of prior fault clustering operations for an execution context that caused a page fault that triggered the memory page fault handler 108, the clustering agent 109 can occasionally confirm fault clustering operations for a plurality of execution contexts, including execution contexts that may not be actively executing and thus are not causing any page faults. By including clustering agent 109, embodiments can ensure that memory footprints remain efficient even for execution contexts that may go through periods of inactivity, such as input/output bound tasks and periodically-executing tasks.

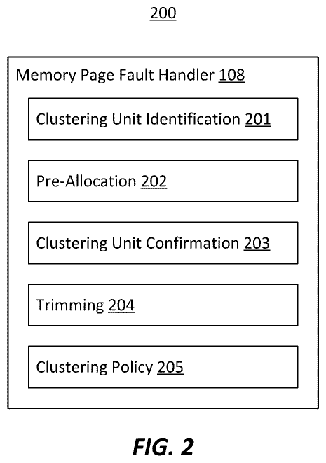

Memory page fault handler 108 is now further described in connection with FIGS. 2-4. FIG. 2 illustrates an example 200 of possible components of the memory page fault handler 108. Each component of memory page fault handler 108 depicted in FIG. 2 represents various functionalities that memory page fault handler 108 may implement under the embodiments described herein. These components—including their identity and arrangement—are presented merely as an aid in describing example embodiments of memory page fault handler 108.

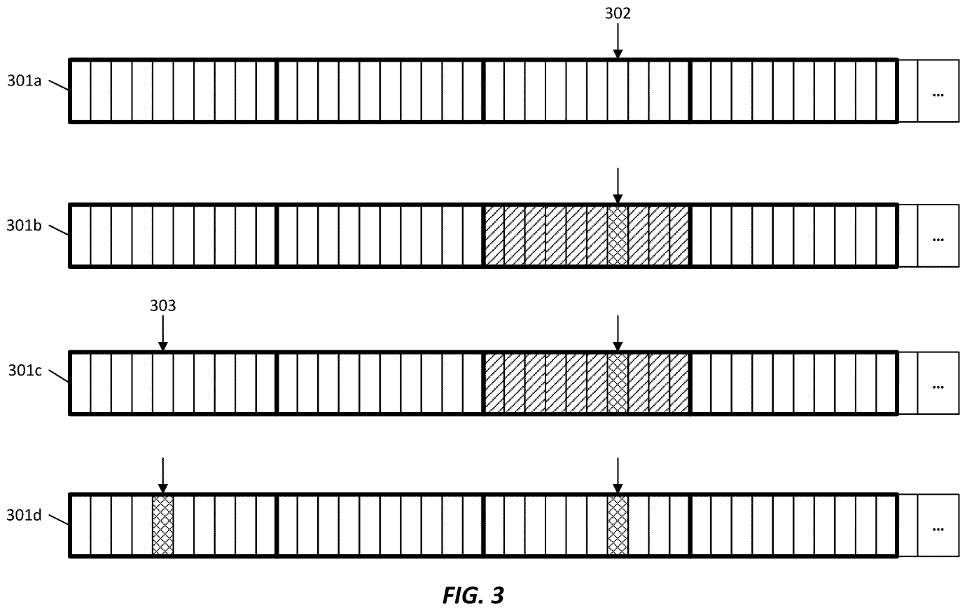

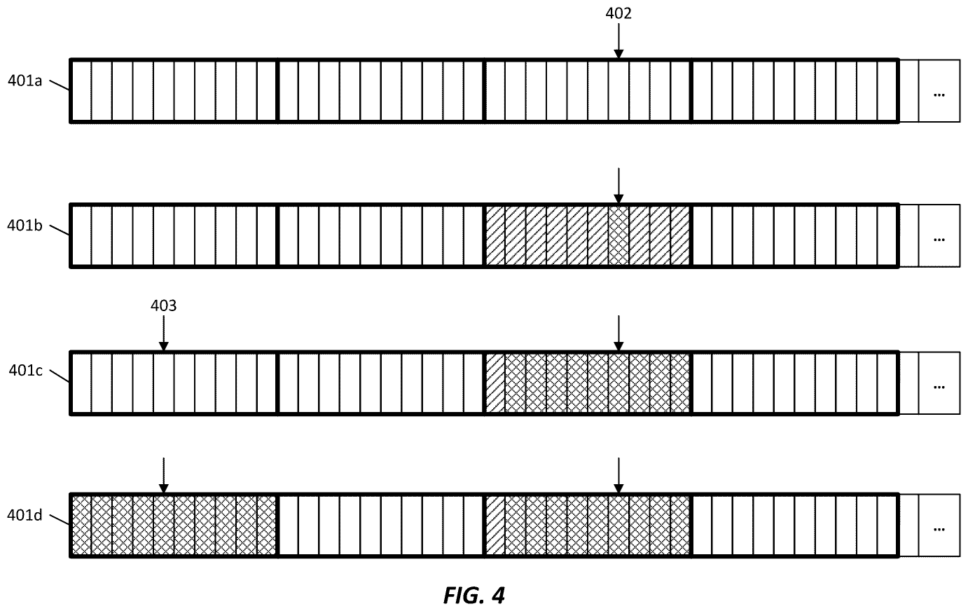

FIGS. 3 and 4 illustrate examples of confirming a fault clustering unit, including an example 300 of trimming the fault clustering unit when proactively satisfied pages were not accessed since they are satisfied (FIG. 3) and an example 400 of confirming that proactively satisfied pages were accessed since they were satisfied (FIG. 4).

FIGS. 3 and 4 each illustrate a portion of a virtual memory space, as defined by a page table 112, at different times. In example 300, for instance, memory space 301a shows a virtual memory space at a first moment in time, memory space 301b shows the same virtual memory space at a subsequent second moment in time, and so on. Within each virtual memory space, individual vertically-oriented rectangles represent a different memory page (e.g., corresponding to a PTE within a page table 112). The virtual memory spaces within FIGS. 3 and 4 may correspond to a thread or process within OS 107, to a thread or process of application 110, to a VM, to a container, etc.

In example 200, the memory page fault handler 108 includes a clustering unit identification component 201. In embodiments, as the memory page fault handler 108 handles a memory page fault for an execution context, the clustering unit identification component 201 identifies one or more additional memory pages to satisfy in addition to a memory page that is the subject of the memory page fault. For example, in FIG. 3 an arrow 302 indicates a memory page within memory space 301a that is the subject of a page fault (e.g., a memory page that was accessed by an execution context, leading to the page fault). This memory page is illustrated as being within a group of contiguous memory pages (in example 300, ten memory pages) that are indicted with a bounding box. In embodiments, based on the memory page fault on the memory page identified by arrow 302, the clustering unit identification component 201 identifies this group of ten memory pages as being a fault clustering unit. Similarly, in FIG. 4 an arrow 402 indicates a memory page within memory space 401a that is the subject of a page fault, and the clustering unit identification component 201 identifies a group of ten memory pages (indicated by a bounding box) that this memory page falls within as being a fault clustering unit.

Notably, the size of a fault clustering unit can vary depending on design choices, implementation, and/or on a clustering policy 205. In some embodiments, based on clustering policy 205, the size of a fault clustering unit varies over time and/or for different execution contexts. In one example, each memory page is four kilobytes in size and each fault clustering unit includes 16 memory pages, resulting in 64 kilobyte clustering units. In other examples of four kilobyte memory pages each fault clustering unit includes 32, 64, etc., memory pages resulting in 128, 256, etc., kilobyte clustering units. In another example, each memory page is 16 kilobytes in size and each fault clustering unit includes eight, 16, 32, etc., memory pages, resulting in 128, 256, 512, etc., kilobyte clustering units. Other configurations are also possible. In some embodiments, fault clustering unit size is based on physical characteristics of memory 103 and/or based on physical characteristics of a cache associated with processor system 102, ensuring that clustering units can be efficiently accessed by processor system 102.

The memory page fault handler 108 also includes a pre-allocation component 202. In embodiments, the pre-allocation component 202 satisfies each memory page in a clustering unit identified by the clustering unit identification component 201. For example, in FIG. 3, memory space 301b shows that each memory page within the clustering unit containing the memory page indicated by arrow 302 has been satisfied, e.g., the corresponding PTEs have been mapped to physical memory pages. Similarly, in FIG. 4, memory space 401b shows that each memory page within the clustering unit containing the memory page indicated by arrow 402 has been satisfied. In FIGS. 3 and 4, some memory pages are shaded with right-leaning diagonal lines, while other memory pages are shaded with cross-hatched lines. This varied shading indicates that, when satisfying memory pages in a clustering unit, the pre-allocation component 202 can apply different properties to the corresponding PTE. In examples, each memory page shaded with right-leaning diagonal lines is marked as valid but not accessed (e.g., a valid bit is set and an accessed bit is clear) while each memory page shaded with cross-hatched lines is marked as both valid but and accessed (e.g., a valid bit is set and an accessed bit also set). As shown, the memory pages that are cross-hatched in memory space 301b and memory space 401b are those pages corresponding to the pages that were accessed by an execution context, leading to the page fault.

In FIG. 1, memory 103 is illustrated as storing clustering data 111. In embodiments, memory page fault handler 108 writes, to clustering data 111, bookkeeping information about fault clustering activity by clustering unit identification component 201 and pre-allocation component 202. The particular format of clustering data 111, and the data contained therein, can vary depending on design and implementation choices, but in general it contains information that would be needed to determine prior fault clustering activity for a given execution context. For example, clustering data 111 may identify one or more clustering units that were previously pre-allocated for an execution context, or may identify of one or more PTEs that were previously pre-allocated for an execution context.

In embodiments, after pre-allocating one or more clustering units by the pre-allocation component 202, the memory page fault handler 108 exits, eventually returning to the execution context. From there, the execution context may access one or more of the pre-allocated memory pages, or may not. For example, in memory space 301c (example 300) that all the memory pages that were previously shaded with right-leaning diagonal lines are still shaded with right-leaning diagonal lines. This means that the execution context has not accessed any of the pre-allocated memory pages between the time of memory space 301b and the time of memory space 301c. For example, perhaps the page fault at arrow 302 was due to an access to a single global variable, and after accessing that variable the execution context didn't access any other memory near that global variable. In contrast, in memory space 401c (example 400) all but one of the memory pages that were previously shaded with right-leaning diagonal lines are now shaded with cross-hatched lines. This means that the execution context has accessed all but one of the pre-allocated memory pages between the time of memory space 401b and the time of memory space 401c. For example, perhaps the page fault at arrow 402 was as due to an initial access to memory storing an image, and after that initial access the execution context continued reading the rest of the image.

The memory page fault handler 108 also includes a clustering unit confirmation component 203. In embodiments, the clustering unit confirmation component 203 revisits one or more prior pre-allocated clustering units to determine whether the memory pre-allocated as part of the clustering unit was accessed by the execution context. In embodiments, clustering unit confirmation component 203 is executed at a page fault of an execution context, and confirms clustering one or more units that were pre-allocated during one or more prior page faults by the execution context. In some examples, clustering unit confirmation component 203 is executed at each page fault by the execution context, every n page faults by the execution context (where n is a positive integer), or after a certain amount of time has elapsed (e.g., based on a number of processor cycles, or based on a number of milliseconds).

As mentioned, in some embodiments, OS 107 includes a clustering agent 109 that periodically confirms the success of fault clustering by the memory page fault handler 108 for a plurality of execution contexts. In these embodiments, the clustering agent 109 also includes a clustering unit confirmation component 203 that is executed on behalf of a plurality of execution contexts, whether or not those execution contexts are actually executing.

In embodiments, the frequency with which the clustering unit confirmation component 203 is executed for a given execution context is dynamically controlled based on clustering policy 205. For example, as fault clustering for a given execution context is found to be more successful (e.g., a greater percentage of pre-allocated pages were accessed), the frequency of execution of clustering unit confirmation component 203 may decrease. Conversely, as fault clustering for a given execution context is found to be less successful (e.g., a lesser percentage of pre-allocated pages were accessed), the frequency of execution of clustering unit confirmation component 203 may increase.

In example 300, an arrow 303 associated with memory space 301c indicates a page fault subsequent to the page fault associated with arrow 302. In embodiments, clustering unit confirmation component 203 is executed at this page fault, and it determines that the fault clustering for the clustering unit allocated in connection with the page fault at arrow 302 was not successful (e.g., none of the pre-allocated memory pages were accessed). In embodiments, based on the unsuccessful fault clustering of the clustering unit, the memory page fault handler 108 uses a trimming component 204 to trim the clustering unit. In embodiments, trimming a clustering unit includes deallocating any non-accessed memory pages in the clustering unit (e.g., freeing the corresponding physical memory pages for re-use), and marking the corresponding PTE(s) as invalid. In example 300, for instance, memory space 301d shows that the pre-allocated memory pages are now deallocated.

In embodiments, based on the unsuccessful fault clustering of the clustering unit, the memory page fault handler 108 also updates the clustering policy 205 for the execution context. For example, the clustering policy 205 may be updated to cease fault clustering for the execution context for a determined amount of time, may be updated to increase a frequency with which the clustering unit confirmation component 203 executes for the execution context, and/or may decrease a size of fault clustering units used for the execution context.

In example 400, an arrow 403 associated with memory space 401c indicates a page fault subsequent to the page fault associated with arrow 402. In embodiments, clustering unit confirmation component 203 is executed at this page fault, and it determines that the fault clustering for the clustering unit allocated in connection with the page fault at arrow 402 was successful (e.g., a majority of the pre-allocated memory pages were accessed). In embodiments, based on the successful fault clustering of the clustering unit, the memory page fault handler 108 uses clustering unit identification component 201 and pre-allocation component 202 to perform further fault clustering for the execution context. In example 400, for instance, memory space 401d shows that a new clustering unit surrounding the memory page indicated by arrow 403 has been pre-allocated.

In embodiments, based on the successful fault clustering of the clustering unit, the memory page fault handler 108 also updates the clustering policy 205 for the execution context. For example, the clustering policy 205 may be updated to decrease a frequency with which the clustering unit confirmation component 203 executes for the execution context, and/or may increase a size of fault clustering units used for the execution context.

In one example, if all pre-allocated memory pages within a clustering unit were accessed, the clustering policy 205 is updated to aggressively perform fault clustering under the supposition that the execution context may be sequentially accessing a block of contiguous memory (e.g., reading an image, a video file, a database). For instance, the clustering policy 205 may be updated to double the prior clustering unit size (e.g., from 64 kilobytes to 128 kilobytes). Then, if, on a subsequent page fault the fault clustering was again found to be successful, the clustering policy 205 may again be updated to double the prior clustering unit size (e.g., from 128 kilobytes to 512 kilobytes). In embodiments, these exponential clustering unit size increases continue so long as the fault clustering is found to be successful. In the case of accesses to large blocks of contiguous memory, such policy updates can dramatically decrease page faults and, in turn, improve program performance.

Notably, the thresholds of successful vs. unsuccessful fault clustering can vary depending on design and implementation, and may even vary over time based on the clustering policy 205. In one example, fault clustering is successful if all pre-allocated memory pages were accessed, and is unsuccessful otherwise. In another example, fault clustering is successful if a majority of pre-allocated memory pages were accessed, and is unsuccessful otherwise.

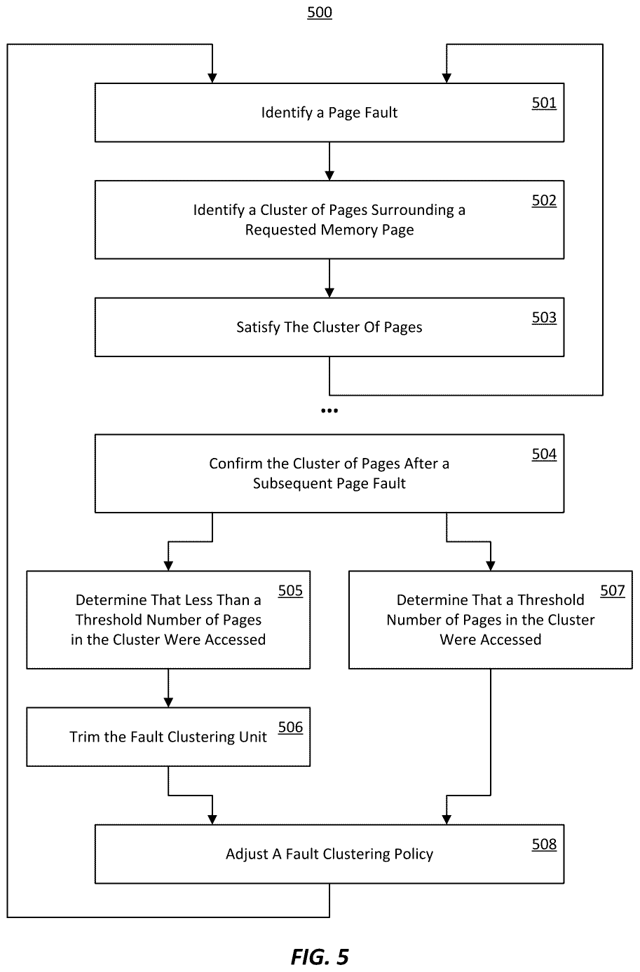

Embodiments are now described in connection with FIG. 5, which illustrates a flow chart of an example method 500 for fault clustering that periodically confirms the success of the clustering by checking whether the proactively fetched pages have been accessed. In embodiments, instructions for implementing method 500 are encoded as computer-executable instructions (e.g., memory page fault handler 108, clustering agent 109) stored on a computer storage medium (e.g., storage medium 104) that are executable by a processor (e.g., processor system 102) to cause a computer system (e.g., computer system 101) to perform method 500.

The following discussion now refers to a method and method acts. Although the method acts are discussed in specific orders or are illustrated in a flow chart as occurring in a particular order, no order is required unless expressly stated or required because an act is dependent on another act being completed prior to the act being performed.

Referring to FIG. 5, in embodiments, method 500 comprises act 501 of identifying an initial page fault for an executable entity. In some embodiments, act 501 comprises identifying a first page fault resulting from a first access by the processor system to a first PTE that is invalid. For instance, example 300 shows a page fault at arrow 302 in memory space 301a, while example 400 shows a page fault at arrow 402 in memory space 401a. As a result of these page faults, processor system 102 triggers execution of memory page fault handler 108.

Method 500 also comprises act 502 of identifying a cluster of pages surrounding a requested memory page. In some embodiments, act 502 comprises identifying a plurality of PTEs as a fault clustering unit, the plurality of PTEs being contiguous and including the first PTE. For instance, in example 300, the clustering unit identification component 201 identifies a block of ten memory pages of which the memory page indicated by arrow 302 is a part. In example 400, the clustering unit identification component 201 identifies a block of ten memory pages of which the memory page indicated by arrow 402 is a part.

Method 500 also comprises act 503 of satisfying the cluster of pages. In some embodiments, act 504 comprises satisfying the fault clustering unit, including allocating a different memory page to each PTE in the plurality of PTEs and marking each PTE in the plurality of PTEs as valid. For instance, example 300 includes memory space 301b, and example 400 includes memory space 401b, in which shaded memory pages indicate memory pages that have been allocated and their PTEs have been marked as valid. As discussed, in embodiments pre-allocated memory pages are allocated with their accessed bits cleared, while the requested memory page is allocated with its accessed bit set. Thus, in embodiments, satisfying the fault clustering unit includes setting a bit associated with the first PTE to an accessed state, and setting a bit associated with each other PTE in the plurality of PTEs to a not accessed state.

An arrow connecting act 503 to act 501 indicates that acts 501-504 may repeat, any number of times, prior to proceeding to act 504. For example, in some embodiments, memory page fault handler 108 performs fault clustering for a given execution context multiple times prior to confirming any of the pre-allocated clustering unit(s). In other embodiments, however, method 500 proceeds to act 504, e.g., after the next page fault for the execution context.

Method 500 also comprises act 504 of confirming the cluster of pages after a subsequent page fault. In some embodiments, act 504 comprises, after a subsequent page fault, confirming the fault clustering unit. For example, after a subsequent page fault for the execution context, pre-allocation component 202 determines if the fault clustering of act 503 was successful. Example 300 illustrates an unsuccessful fault clustering (e.g., there is no difference between the accessed memory pages in memory space 301b versus memory space 301c), while example 400 illustrates a successful fault clustering (e.g., most of the pre-allocated memory pages have changed to accessed in memory space 401b versus memory space 401c).

In some examples, such as the situation shown in example 300, method 500 comprises act 505 of determining that less than a threshold number of pages in the cluster were accessed. In some embodiments, act 505 comprises determining that a threshold number of PTEs in the plurality of PTEs were not accessed after the first page fault. In embodiments, determining that the threshold number of PTEs in the plurality of PTEs were not accessed after the first page fault comprises determining a number of bits associated with the plurality of PTEs that are in the accessed state versus the not accessed state (e.g., with the number of bits in the accessed state not meeting a threshold compared to the number of bits in the not accessed state).

If the threshold number of pages in the cluster were accessed (act 505), method 500 also comprises act 506 of trimming the fault clustering unit. In some embodiments, act 506 comprises trimming the fault clustering unit, including deallocating a memory page from a PTE in the plurality of PTEs that was not accessed after the first page fault, and marking the PTE as invalid. For instance, in example 300, the pre-allocated memory pages have been trimmed in memory space 301d versus memory space 301c. In embodiments, trimming the fault clustering unit includes deallocating a corresponding memory page from each PTE in the plurality of PTEs that was not accessed after the first page fault, and marking the PTE as invalid.

In some examples, such as the situation shown in example 400, method 500 comprises act 507 of determining that a threshold number of pages in the cluster were accessed. In some embodiments, act 507 comprises determining that a threshold number of PTEs in the plurality of PTEs were accessed after the first page fault. In embodiments, determining that the threshold number of PTEs in the plurality of PTEs were accessed after the first page fault comprises determining a number of bits associated with the plurality of PTEs that are in the accessed state versus the not accessed state (e.g., with the number of bits in the accessed state exceeding a threshold compared to the number of bits in the not accessed state).

Regardless of whether method 500 takes a path through act 505 or through act 507, in embodiments, method 500 also comprises act 508 of adjusting a fault clustering policy. In some embodiments, such as when following the path through act 505, act 508 comprises adjusting a fault clustering policy to decrease an amount of future fault clustering (e.g., by ceasing fault clustering for the execution unit for a determined amount of time, by decreasing a clustering unit size for an execution context, and/or by increasing a frequency of confirmations for the execution unit). In some embodiments, such as when following the path through act 507, act 508 comprises adjusting a fault clustering policy to increase an amount of future fault clustering (e.g., by increasing a clustering unit size for an execution context, and/or by decreasing a frequency of confirmations for the execution unit).

An arrow connecting act 508 to act 501 indicates that method 500 can repeat any number of times for an execution context.

Thus, described herein are techniques for memory access fault clustering without memory footprint increase. A device identifies a first page fault resulting from an access by a processor system to an invalid first PTE. The device identifies a plurality of PTEs as a fault clustering unit, the plurality of PTEs being contiguous and including the first PTE. The device satisfies the fault clustering unit, including allocating a different memory page to each PTE in the plurality of PTEs and marking each PTE as valid. After a subsequent page fault, the device confirms the fault clustering unit, including determining whether a threshold number of PTEs in the plurality of PTEs were accessed after the first page fault. If the threshold is not met, the device trims the fault clustering unit, including deallocating a memory page from a PTE in the plurality of PTEs that was not accessed after the first page fault and marking the PTE as invalid.

Alternatively or in addition to the other examples described herein, examples include any combination of the following:

Clause 1. A method implemented in a computer system that includes a processor system and a system memory, comprising: identifying a first page fault resulting from a first access by the processor system to a first PTE that is invalid; identifying a plurality of PTEs as a fault clustering unit, the plurality of PTEs being contiguous and including the first PTE; satisfying the fault clustering unit, including allocating a different memory page to each PTE in the plurality of PTEs and marking each PTE in the plurality of PTEs as valid; and after a subsequent page fault, confirming the fault clustering unit, including: determining that a threshold number of PTEs in the plurality of PTEs were not accessed after the first page fault; and trimming the fault clustering unit, including deallocating a memory page from a PTE in the plurality of PTEs that was not accessed after the first page fault, and marking the PTE as invalid.

Clause 2. The method of clause 1, wherein the method is performed by a memory fault handler.

Clause 3. The method of clause 1, wherein trimming the fault clustering unit includes deallocating a corresponding memory page from each PTE in the plurality of PTEs that was not accessed after the first page fault, and marking the PTE as invalid.

Clause 4. The method of clause 1, wherein satisfying the fault clustering unit includes: setting a bit associated with the first PTE to an accessed state; and setting a bit associated with each other PTE in the plurality of PTEs to a not accessed state.

Clause 5. The method of clause 4, wherein determining that the threshold number of PTEs in the plurality of PTEs were not accessed after the first page fault comprises determining a number of bits associated with the plurality of PTEs that are in the accessed state versus the not accessed state.

Clause 6. The method of clause 1, wherein the first page fault results from a first memory access by an execution context, and the subsequent page fault results from a second memory access by the execution context.

Clause 7. The method of clause 6, wherein the execution context is a thread, a process, a virtual machine, or a container.

Clause 8. The method of clause 6, wherein confirming the fault clustering unit is performed as part of a memory fault handler for the subsequent page fault.

Clause 9. The method of clause 1, wherein confirming the fault clustering unit is performed by a fault clustering agent that operates on behalf of a plurality of execution context.

Clause 10. The method of clause 1, wherein: the first page fault results from a first memory access by an execution context; and the method further comprises adjusting a fault clustering policy to reduce an amount of future fault clustering for the execution context.

Clause 11. The method of clause 10, wherein adjusting the fault clustering policy includes decreasing a number of PTEs in each fault clustering unit for the execution context.

Clause 12. The method of clause 10, wherein adjusting the fault clustering policy includes disabling fault clustering for the execution context for a determined duration.

Clause 13. The method of clause 1, wherein satisfying the fault clustering unit comprises allocating a contiguous set of memory pages to the plurality of PTEs.

Clause 14. The method of clause 1, wherein trimming the fault clustering unit comprises trimming a contiguous set of memory pages as a unit.

Clause 15. A method implemented in a computer system that includes a processor system and a system memory, comprising: identifying a first page fault resulting from a first access by the processor system to a first PTE that is invalid, the first page fault resulting from a first memory access by an execution context; identifying a plurality of PTEs as a fault clustering unit, the plurality of PTEs being contiguous and including the first PTE; satisfying the fault clustering unit, including allocating a different memory page to each PTE in the plurality of PTEs and marking each PTE in the plurality of PTEs as valid; and after a subsequent page fault, confirming the fault clustering unit, including: determining that a threshold number of PTEs in the plurality of PTEs were accessed after the first page fault; and adjusting a fault clustering policy to increase an amount of future fault clustering for the execution context.

Clause 16. The method of clause 15, wherein adjusting the fault clustering policy includes increasing a number of PTEs in each fault clustering unit for the execution context.

Clause 17. The method of clause 15, wherein: the subsequent page fault results from a second memory access by the execution context; and confirming the fault clustering unit is performed as part of a memory fault handler for the subsequent page fault.

Clause 18. The method of clause 15, wherein confirming the fault clustering unit is performed as part of a memory fault handler for the subsequent page fault.

Clause 19. The method of clause 15, wherein satisfying the fault clustering unit comprises allocating a contiguous set of memory pages to the plurality of PTEs.

Clause 20. A computer storage medium that stores computer-executable instructions that are executable by a processor system to at least: identify a first page fault resulting from a first access by the processor system to a first PTE that is invalid, the first page fault resulting from a first memory access by an execution context; identify a plurality of PTEs as a fault clustering unit, the plurality of PTEs being contiguous and including the first PTE; satisfy the fault clustering unit, including: allocating a different memory page to each PTE in the plurality of PTEs; and marking each PTE in the plurality of PTEs as valid; identify a second page fault resulting from a second access by the processor system to a second PTE that is invalid, the second page fault resulting from a second memory access by the execution context; determine that a threshold number of PTEs in the plurality of PTEs were not accessed after the first page fault; and trim the fault clustering unit, including: deallocating a corresponding memory page from each PTE in the plurality of PTEs that was not accessed after the first page fault; and marking the PTE as invalid.

Embodiments of the disclosure comprise or utilize a special-purpose or general-purpose computer system (e.g., computer system 101) that includes computer hardware, such as, for example, a processor system (e.g., processor system 102) and system memory (e.g., memory 103), as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media (e.g., storage medium 104). Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system that includes a processor system and a system memory, comprising:
identifying a first page fault resulting from a first access by the processor system to a first page table entry (PTE) that is invalid;
identifying a plurality of PTEs as a fault clustering unit, the plurality of PTEs being contiguous and including the first PTE;
satisfying the fault clustering unit, including allocating a different memory page to each PTE in the plurality of PTEs and marking each PTE in the plurality of PTEs as valid; and
after a subsequent page fault, confirming the fault clustering unit, including:
determining that a threshold number of PTEs in the plurality of PTEs were not accessed after the first page fault; and
trimming the fault clustering unit, including deallocating a memory page from a PTE in the plurality of PTEs that was not accessed after the first page fault, and marking the PTE as invalid.

2. The method of claim 1, wherein the method is performed by a memory fault handler.

3. The method of claim 1, wherein trimming the fault clustering unit includes deallocating a corresponding memory page from each PTE in the plurality of PTEs that was not accessed after the first page fault, and marking the PTE as invalid.

4. The method of claim 1, wherein satisfying the fault clustering unit includes:
setting a bit associated with the first PTE to an accessed state; and
setting a bit associated with each other PTE in the plurality of PTEs to a not accessed state.

5. The method of claim 4, wherein determining that the threshold number of PTEs in the plurality of PTEs were not accessed after the first page fault comprises determining a number of bits associated with the plurality of PTEs that are in the accessed state versus the not accessed state.

6. The method of claim 1, wherein the first page fault results from a first memory access by an execution context, and the subsequent page fault results from a second memory access by the execution context.

7. The method of claim 6, wherein the execution context is a thread, a process, a virtual machine, or a container.

8. The method of claim 6, wherein confirming the fault clustering unit is performed as part of a memory fault handler for the subsequent page fault.

9. The method of claim 1, wherein confirming the fault clustering unit is performed by a fault clustering agent that operates on behalf of a plurality of execution context.

10. The method of claim 1, wherein:
the first page fault results from a first memory access by an execution context; and
the method further comprises adjusting a fault clustering policy to reduce an amount of future fault clustering for the execution context.

11. The method of claim 10, wherein adjusting the fault clustering policy includes decreasing a number of PTEs in each fault clustering unit for the execution context.

12. The method of claim 10, wherein adjusting the fault clustering policy includes disabling fault clustering for the execution context for a determined duration.

13. The method of claim 1, wherein satisfying the fault clustering unit comprises allocating a contiguous set of memory pages to the plurality of PTEs.

14. The method of claim 1, wherein trimming the fault clustering unit comprises trimming a contiguous set of memory pages as a unit.

15. A method implemented in a computer system that includes a processor system and a system memory, comprising:
identifying a first page fault resulting from a first access by the processor system to a first page table entry (PTE) that is invalid, the first page fault resulting from a first memory access by an execution context;
identifying a plurality of PTEs as a fault clustering unit, the plurality of PTEs being contiguous and including the first PTE;
satisfying the fault clustering unit, including allocating a different memory page to each PTE in the plurality of PTEs and marking each PTE in the plurality of PTEs as valid; and
after a subsequent page fault, confirming the fault clustering unit, including:
determining that a threshold number of PTEs in the plurality of PTEs were accessed after the first page fault; and
adjusting a fault clustering policy to increase an amount of future fault clustering for the execution context.

16. The method of claim 15, wherein adjusting the fault clustering policy includes increasing a number of PTEs in each fault clustering unit for the execution context.

17. The method of claim 15, wherein:
the subsequent page fault results from a second memory access by the execution context; and
confirming the fault clustering unit is performed as part of a memory fault handler for the subsequent page fault.

18. The method of claim 15, wherein confirming the fault clustering unit is performed as part of a memory fault handler for the subsequent page fault.

19. The method of claim 15, wherein satisfying the fault clustering unit comprises allocating a contiguous set of memory pages to the plurality of PTEs.

20. A computer storage medium that stores computer-executable instructions that are executable by a processor system to at least:
identify a first page fault resulting from a first access by the processor system to a first page table entry (PTE) that is invalid, the first page fault resulting from a first memory access by an execution context;
identify a plurality of PTEs as a fault clustering unit, the plurality of PTEs being contiguous and including the first PTE;
satisfy the fault clustering unit, including:
allocating a different memory page to each PTE in the plurality of PTEs; and
marking each PTE in the plurality of PTEs as valid;
identify a second page fault resulting from a second access by the processor system to a second PTE that is invalid, the second page fault resulting from a second memory access by the execution context;
determine that a threshold number of PTEs in the plurality of PTEs were not accessed after the first page fault; and
trim the fault clustering unit, including:
deallocating a corresponding memory page from each PTE in the plurality of PTEs that was not accessed after the first page fault; and
marking the PTE as invalid.
